(19) United States
(12) Patent Application Publication
(10) Pub. No.: US 2024/0015702 A1
(43) Pub. Date: Jan. 11, 2024

(54) METHOD FOR RESELECTING SIDELINK RESOURCE AND APPARATUS FOR THE SAME

(71) Applicant: FUJITSU LIMITED, Kawasaki-shi (JP)

(72) Inventors: Pengyu JI, Beijing (CN); Jian ZHANG, Beijing (CN); Guorong LI, Beijing (CN); Lei ZHANG, Beijing (CN); Xin WANG, Beijing (CN)

(73) Assignee: FUJITSU LIMITED, Kawasaki-shi (JP)

(21) Appl. No.: 18/370,982

(22) Filed: Sep. 21, 2023

Related U.S. Application Data
(63) Continuation of application No. PCT/CN2021/085134, filed on Apr. 1, 2021.

(51) Int. Cl. H04W 72/02; H04W 72/0446; H04W 72/25

(52) U.S. Cl. CPC H04W 72/02; H04W 72/0446; H04W 72/25

(57) ABSTRACT

An apparatus for reselecting a sidelink resource includes a memory, and a processor coupled to the memory and configured to take one or more candidate slots as a second candidate slot set of a second transmission period, wherein the one or more candidate slots are obtained based on one or more first candidate slots of a first transmission period and N transmission periods, where, N is the number of periods spacing the second transmission period and the first transmission period apart.

### CROSS REFERENCE TO RELATED APPLICATION

This application is a continuation application of International Application PCT/CN2021/085134 filed on Apr. 1, 2021, and designated the U.S., the entire contents of which are incorporated herein by reference.

### TECHNICAL FIELD

This disclosure relates to the field of communication technologies.

### BACKGROUND

In Rel-15 and previous versions of Vehicle to Everything (V2X) communication, two allocation modes of sidelink resources, such as a Mode 1 and a Mode 2, are supported. For the Mode 1, the sidelink resources are allocated by a network device (such as a base station). For the Mode 2, transmission resources are autonomously selected by a terminal equipment, that is, the transmission resources are obtained in a sensing or detection-resource selection process.

On the other hand, New Radio (NR) V2X is one of research projects of Rel-16 standardization. As compared with Long Term Evolution (LTE) V2X, the NR V2X needs to support a plurality of new scenarios and new services (such as remote driving, autonomous driving and fleet driving), and needs to meet higher technical indicators (high reliability, low latency, high data rate).

In a Rel-17 sidelink enhancement topic, an important objective is to save power for a certain terminal equipment (such as a pedestrian user equipment (P-UE)). As an effective power-saving mechanism, partial sensing is considered as a resource selection mechanism for power saving in Rel-17.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

The inventors found that for a terminal equipment that supports periodic-based partial sensing, power consumption may be increased and unnecessary waste may occur. In addition, for a terminal equipment that supports partial sensing, resource re-evaluation/resource pre-emption detection may lead to insufficient candidate resources during resource reselection, and therefore, the possible interference is increased or the probability of resource collisions is increased.

To address at least one of the above problems, embodiments of this disclosure provide a sidelink resource reselection method and apparatus.

According to one aspect of the embodiments of this disclosure, there is provided a method for reselecting a sidelink resource, including:
determining, by a terminal equipment, a first monitoring slot set for performing partial sensing for a first candidate slot set of a first transmission period; and determining a second monitoring slot set for performing partial sensing of a second transmission period according to the first monitoring slot set of the first transmission period and a second candidate slot set of the second transmission period;
monitoring sidelink control information in the second monitoring slot set of the second transmission period; and
performing resource reselection in the second candidate slot set of the second transmission period according to a monitoring result.

According to another aspect of the embodiments of this disclosure, there is provided an apparatus for reselecting a sidelink resource, including:
a determining unit configured to determine a first monitoring slot set for performing partial sensing for a first candidate slot set of a first transmission period, and determine a second monitoring slot set for performing partial sensing of a second transmission period according to the first monitoring slot set of the first transmission period and a second candidate slot set of the second transmission period;
a monitoring unit configured to monitor sidelink control information in the second monitoring slot set of the second transmission period; and
a reselection unit configured to perform resource reselection in the second candidate slot set of the second transmission period according to a monitoring result.

According to another aspect of the embodiments of this disclosure, there is provided a method for reselecting a sidelink resource, including:
taking, by a terminal equipment, first candidate slots of a first transmission period as a second candidate slot set of a second transmission period after translating the first candidate slots of the first transmission period backwards by N current transmission periods in the time domain, where N is the number of periods spacing the second transmission period and the first transmission period apart.

According to another aspect of the embodiments of this disclosure, there is provided an apparatus for reselecting a sidelink resource, including:
a determining unit configured to take first candidate slots of a first transmission period as a second candidate slot set of a second transmission period after translating the first candidate slots of the first transmission period backwards by N current transmission periods in the time domain, where N is the number of periods spacing the second transmission period and the first transmission period apart.

According to another aspect of the embodiments of this disclosure, there is provided a method for reselecting a sidelink resource, including:
taking, by a terminal equipment, at least one slot after a third candidate slot set used for initial resource selection as a fourth candidate slot set used for resource reselection, determining a fourth monitoring slot set for performing partial sensing for the third candidate slot set, and determining a fifth monitoring slot set to which the fourth candidate slot set used for resource reselection corresponds according to the fourth monitoring slots;
monitoring sidelink control information in the fifth monitoring slot set; and
performing resource reselection in the fourth candidate slot set used for resource reselection according to a monitoring result.

According to another aspect of the embodiments of this disclosure, there is provided an apparatus for reselecting a sidelink resource, including:
a determining unit configured to take at least one slot after a third candidate slot set used for initial resource selection as a fourth candidate slot set used for resource reselection, determine a fourth monitoring slot set for performing partial sensing for the third candidate slot set, and determine a fifth monitoring slot set to which the fourth candidate slot set used for resource reselection corresponds according to the fourth monitoring slots;
a monitoring unit configured to monitor sidelink control information in the fifth monitoring slot set; and
a reselecting unit configured to reselect resources in the fourth candidate slot set used for resource reselection according to a monitoring result.

One of the advantageous effects of the embodiments of this disclosure is that the second monitoring slot set for performing partial sensing of the second transmission period is determined according to the first monitoring slot set of the first transmission period and the second candidate slot set of the second transmission period, thus monitoring for resource reselection may be performed on a portion of the slots, unnecessary power consumption may be avoided and the effect of power saving may be improved.

In addition, at least one slot after the candidate slot set used for initial resource selection is used as the candidate slot set used for resource reselection, thus the number of candidate resources during resource reselection may be increased, the possible interference may be reduced or the probability of resource collisions may be reduced, and the system performance may be improved.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, or components thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram illustrating a communication system according to an embodiment of this disclosure;

FIG. 2 is a schematic diagram illustrating a terminal equipment performing sidelink resource selection;

FIG. 3 is a schematic diagram illustrating a terminal equipment performing partial sensing;

FIG. 4 is another schematic diagram illustrating a terminal equipment performing partial sensing;

FIG. 5 is an example diagram illustrating a resource re-evaluation process;

FIG. 6 is an example diagram illustrating a resource pre-emption detection process;

FIG. 7 is an example diagram illustrating reselection of periodic reserved resources;

FIG. 8 is an example diagram illustrating power consumption caused by periodic-based partial sensing;

FIG. 9 is an example diagram illustrating insufficient candidate resources caused by resource re-evaluation/resource pre-emption detection in partial sensing;

FIG. 10 is a schematic diagram illustrating a method for reselecting sidelink resources according to an embodiment of this disclosure;

FIG. 11 is a schematic diagram illustrating determination of a second monitoring slot set according to an embodiment of this disclosure;

FIG. 12 is another schematic diagram illustrating determination of a second monitoring slot set according to an embodiment of this disclosure;

FIG. 13 is another schematic diagram illustrating determination of a second monitoring slot set according to an embodiment of this disclosure;

FIG. 14 is another schematic diagram illustrating determination of a second monitoring slot set according to an embodiment of this disclosure;

FIG. 15 is a schematic diagram illustrating a method for reselecting a sidelink resource according to an embodiment of this disclosure;

FIG. 16 is a schematic diagram illustrating determination of a sixth monitoring slot set according to an embodiment of this disclosure;

FIG. 17 is a schematic diagram illustrating determination of a fifth monitoring slot set according to an embodiment of this disclosure;

FIG. 18 is another schematic diagram illustrating determination of the fifth monitoring slot set according to an embodiment of this disclosure;

FIG. 19 is a schematic diagram illustrating an apparatus for reselecting a sidelink resource according to an embodiment of this disclosure;

FIG. 20 is a schematic diagram illustrating a network device according to an embodiment of this disclosure; and

FIG. 21 is a schematic diagram illustrating a terminal equipment according to an embodiment of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and New Radio (NR) in the future, etc., and/or other communication protocols that are currently known or will be developed in the future.

In the embodiments of this disclosure, the term “network device”, for example, refers to a device in a communication system that accesses terminal equipment to the communication network and provides services for the terminal equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.), an integrated access and backhaul (IAB) node, or an IAB-DU or an IAB-donor. The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal equipment” refers to, for example, equipment accessing to a communication network and receiving network services via a network device. The terminal equipment may be fixed or mobile, and may also be referred to as a mobile station (MS), a terminal, a subscriber station (SS), an access terminal (AT), and a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” in this text may refer to a network device, and may also refer to terminal equipment, except otherwise specified.

A scenario of an embodiment in this disclosure shall be described below by way of examples; however, this disclosure is not limited thereto.

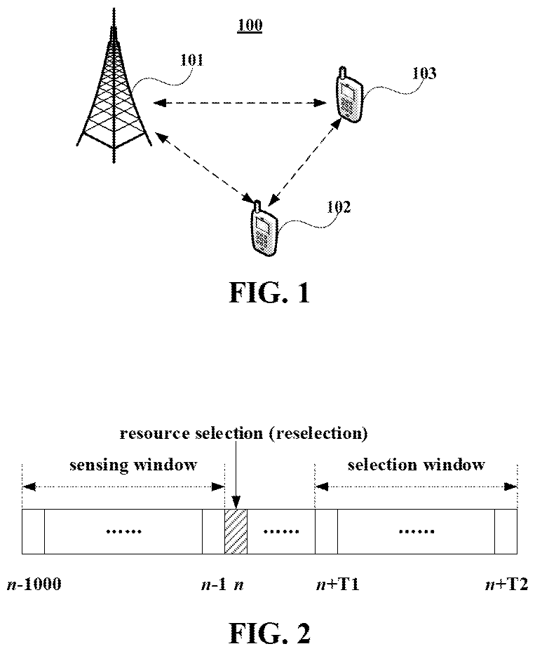

FIG. 1 is a schematic diagram illustrating a communication system according to an embodiment of this disclosure, which schematically illustrates a situation in which a terminal equipment and a network device are used as an example. As shown in FIG. 1, a communication system 100 may include a network device 101 and terminal equipment 102 and 103. For simplicity, FIG. 1 only illustrates two terminal equipment and one network device as an example, however, this disclosure is not limited thereto.

In an embodiment of this disclosure, existing services or services that may be implemented in the future may be transmitted between the network device 101 and the terminal equipment 102 and 103. For example, these services may include but are not limited to: an enhanced Mobile Broadband (eMBB), a massive Machine Type Communication (mMTC) and an Ultra-Reliable and Low-Latency Communication (URLLC), etc.

It should be noted that FIG. 1 illustrates that both the terminal equipment 102 and 103 fall within the coverage of the network device 101, however, this disclosure is not limited thereto. Neither of the terminal equipment 102, 103 may fall within the coverage of the network device 101, or the terminal equipment 102 may fall within the coverage of the network device 101 and the other terminal equipment 103 may fall outside the coverage of the network device 101.

In an embodiment of this disclosure, sidelink transmissions may be performed between the two terminal equipment 102 and 103. For example, both the two terminal equipment 102 and 103 may perform sidelink transmissions within the coverage of the network device 101 to perform V2X communications, or may perform sidelink transmissions outside the coverage of the network device 101 to perform V2X communications. The terminal equipment 102 may perform sidelink transmissions within the coverage of the network device 101 and the other terminal equipment 103 may perform sidelink transmissions outside the coverage of the network device 101 to perform V2X communications.

In an embodiment of this disclosure, the terminal equipment 102 and/or 103 may autonomously select sidelink resources (i.e., use of a mode 2), and in this case, the sidelink transmissions may be independent of the network device 101, that is, the network device 101 is selectable. Of course, the embodiment of this disclosure may also combine the autonomous selection of sidelink resources (i.e., use of the mode 2) with an allocation of sidelink resources by the network device (i.e., use of a mode 1). However, this disclosure is not limited thereto.

In V2X, the terminal equipment may obtain sidelink transmission resources in the process of sensing detection+resource selection, in which sensing may be performed continuously to obtain an occupancy of resources in a resource pool. For example, the terminal equipment may estimate the occupancy of the resources in a later period of time (referred to as a selection window) according to the occupancy of the resources in a previous period of time (referred to as a sensing window).

FIG. 2 is a schematic diagram illustrating a terminal equipment performing sidelink resource selection. As shown in FIG. 2, the terminal equipment may obtain the occupancy of the resources of the sensing window, for example, by detecting sidelink control information (SCI) and time-frequency resource reference signals at different positions in (n−1000)^{th} to (n−1)^{th} subframes or slots (i.e., sensing window), and therefore may estimate a situation of the occupancy of the resources of (n+T1)^{th} to (n+T2) th subframes or slots (i.e., selection window).

For example, in a case where there is sidelink data to be transmitted, a physical layer of the terminal equipment obtains a granularity R_{x,y} of resource selection from a high layer (such as a media access control (MAC) layer). The granularity may represent a series of consecutive subchannels within a subframe, each of the subchannels includes more than one consecutive physical resource block (PRB), the number of PRBs may be determined by a resource pool, and the resource pool is configured or preconfigured by a network device (such as a base station). A set of R_{x,y}-sized resources (hereinafter referred to as R_{x,y} candidate resources) in all subframes in an entire selection window is initially defined as Set A.

The terminal equipment may exclude some candidate resources in the Set A (a set of candidate resources) according to a result of detection within the sensing window before the data to be transmitted arrives. For example, in NR V2X of Rel-16, the R_{x,y} candidate resources need to be excluded:
the SCI is detected in a slot slot tₘ^{SL}, and an indicated reserved period P_{rsvp_RX} and an indicated priority prio_{RX} of corresponding data are obtained from a corresponding SCI format 1-A;
a measurement result of a reference signal receiving power (RSRP) of a de-modulation reference signal (DMRS) of a physical sidelink control channel (PSCCH) or a DMRS of a physical sidelink shared channel (PSSCH) corresponding to the detected SCI format 1-A is greater than Th(prio_{RX}) , where a Th(prio_{RX}) value is a corresponding high layer parameter ThresRSRP_pi_pj, pⱼ is a priority of data to be transmitted of a current UE indicated by a high layer, and pᵢ is a priority indicated in the detected SCI of other UEs; and
corresponding resources indicated by the SCI format 1-A and resources of a next period that may be reserved (for example, a plurality of short periods less than 100 ms may be included), are overlapped with resources R_{x,y+j×P′}_{_{rsvp_TX}} in the candidate set—Set A currently transmitted, j=0, 1, . . . , Cᵣₑₛₑₗ−1. The resources here refer to candidate resources of the Set A in a current selection window, and resources at periodic positions that may be reserved in subsequent periods of a periodic service.

If, after the above resources are excluded, the number of R_{x,y} candidate resources remaining in the Set A is less than X % (such as 20%) of an initial total, a threshold of the RSRP is increased by 3 dB, is re-excluded from the initial Set A until the number of R_{x,y} candidate resources remaining in the Set A is greater than or equal to 20% of the initial total.

The R_{x,y} candidate resources in the Set A are placed in a Set B, where the Set B is a set that is initially empty.

The above process of obtaining the set of the candidate resources by the physical layer may be referred to as Step 1. Then, the physical layer of the terminal equipment may report the Set B to a MAC layer. The following process of selecting resources in the set of the candidate resources by the MAC layer may be referred to as Step 2.

The MAC layer performs random selection in the Set B, selects a candidate resource and generates a grant for this transmission. In addition, a modulation and coding scheme (MCS) is selected from the indicated resources for data transmission.

If retransmissions are configured for the MAC layer before resources are selected, for example, the number of transmissions is 2, after selecting a resource, the MAC layer randomly selects another resource and generates another grant within a set consisting of other resources that satisfy a time domain range, such as ([−15, 15]), indicated by the SCI for initial transmission, but do not include a subframe where the selected resource is located in a set of remaining available resources, and an MCS is selected among the indicated resources for data retransmission. A first resource of the two resources in time is used to transmit initial transmission data, and a second resource in time is used to transmit retransmission data. If there is no such available resource, current transmissions do not support retransmissions, that is, the number of transmissions becomes 1.

It should be noted that the process of sensing detection+resource selection in V2X is only schematically described above. Reference may also be made to Section 14.1.1.6 in 3GPP TS 36.213 V15.2.0 for the specific disclosure of the process.

In LTE V2X, the terminal equipment may support a resource selection mechanism of partial sensing.

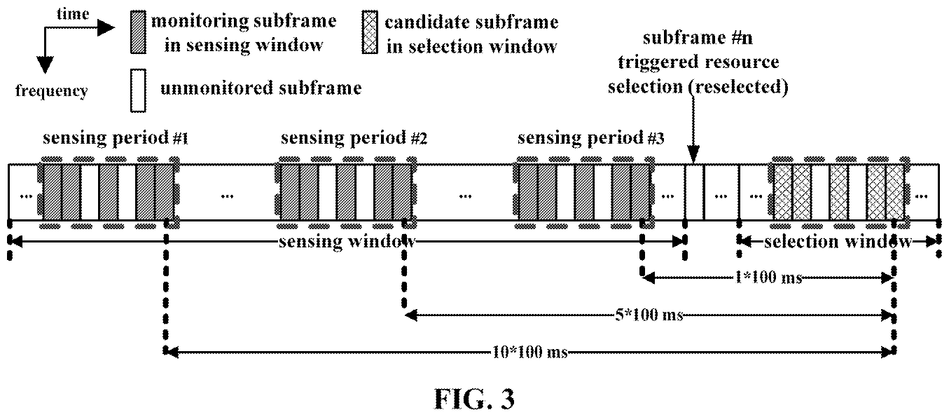

FIG. 3 is a schematic diagram illustrating a terminal equipment performing partial sensing. As shown in FIG. 3, Y subframes may be selected in a corresponding selection window, and transmission resources may be selected from candidate resources in the Y subframes. For example, Y needs to be greater than or equal to a parameter minNumCandidateSF configured in a high layer. Accordingly, if a k-th bit is configured as 1 in a bitmap gapCandidateSensing configured in a high layer, for a subframe included in a set of selected Y subframes, a subframe corresponding to the k^{th} bit in the sensing window needs to be monitored. In short, the subframes in the selection window corresponding to some subframes monitored in the sensing window may only be selected as subframes in the set of Y subframes.

In NR V2X, it may be restricted that a candidate slot selected in the selection window is a slot monitored in a previous corresponding time domain position, in this way, interference from periodic transmission of selected resources by other terminal equipment in the same resource pool may be eliminated to guarantee reliable performance of the system, this type of partial sensing may be defined as periodic-based partial sensing.

For the transmitting terminal equipment that performs the periodic-based partial sensing, a physical sidelink control channel (PSCCH) is detected in the monitoring slot corresponding to the selected candidate slot, that is, corresponding first stage sidelink control information (1^{st} stage SCI) is detected to obtain the occupancy of the resources of other terminal equipment.

For example, if a slot t_{y}^{SL} is selected and included in candidate slots (Y slots), the terminal equipment needs to monitor a corresponding slot t_{y-k×P}_{ᵣₑₛₑᵣᵥₑ}^{SL}, the related arts may be referred to for the definition of k and Pᵣₑₛₑᵣᵥₑ. Pᵣₑₛₑᵣᵥₑ is a set of corresponding period values (i.e., values after the slot is converted into a logical slot) that need to be monitored for one candidate slot when the terminal equipment performs period-based partial sensing, which may be a full set or a sub-set of a candidate period set configured by sl-ResourceReservePeriodList. The parameter sl-ResourceReservePeriodList included in a resource pool configures a candidate period value of a period reservation allowed by the resource pool. k is the number of periods between the candidate slots and the corresponding monitoring slot that needs to be monitored. For the selection of the k value, the closer to the time n when the resource selection occurs, or the closer to a first slot y0 in the Y candidate slots, the more reliable the obtained sensing result.

For the periodic reserved SCI monitored in t_{y-k×P}_{ᵣₑₛₑᵣᵥₑ}^{SL} (wherein the indicated reserved period is Pᵣₑₛₑᵣᵥₑ), if reference signal received power (RSRP) corresponding to the SCI is greater than a threshold, frequency domain resources indicated by the SCI correspond to resources R in a slot after k Pᵣₑₛₑᵣᵥₑ periods, candidate resources overlapped with the resources R in a current transmission period or a subsequent transmission period need to be excluded in the corresponding slot t_{y}^{SL}.

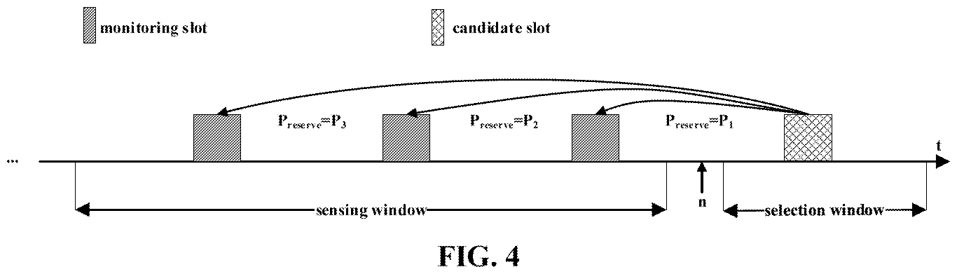

FIG. 4 is another schematic diagram illustrating the terminal equipment performing partial sensing. As shown in FIG. 4, assuming that Pᵣₑₛₑᵣᵥₑ={P₁, P₂, P₃}, for each candidate slot, the terminal equipment may determine one or more corresponding k values for each Pᵣₑₛₑᵣᵥₑ, respectively. For each period value in the figure, k is determined to be 1, so as to obtain a corresponding slot that needs to be monitored for the candidate slot.

On the other hand, in Rel-16 NR V2X, the terminal equipment also needs to perform a resource re-evaluation process and/or a resource pre-emption detection process, after selecting one or more transmission resources corresponding to a current transport block (TB) in the candidate set through the MAC layer (Step 2), and determines a priority of sidelink transmissions, so as to decide whether to reselect the resources that have been selected. This is mainly to eliminate any possible interference caused by aperiodic services or short-period services.

In the resource re-evaluation process, at a point in time before each SCI is transmitted (defined as T3), the resources reserved for the SCI (not including the current transmission resources in the same slot as the PSCCH where the SCI is located, but the subsequent resources reserved for the SCI, these resources have not been indicated or reserved by the SCI) are re-evaluated to determine whether the reserved resources are overlapped with the resources occupied by other terminal equipment after a period of time and the measured RSRP value is greater than a corresponding threshold. The resource re-evaluation process is performed based on the physical layer obtaining the set of the candidate resources (Step 1). If a resource is no longer in the set of the candidate resources reported in the resource re-evaluation process, the resource needs to be reselected.

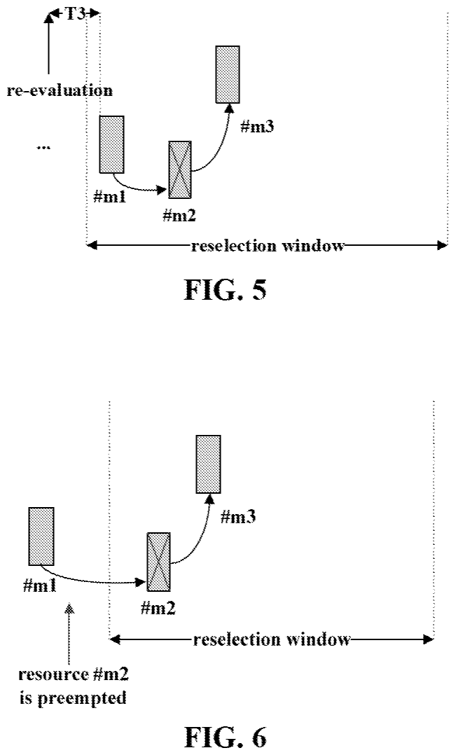

FIG. 5 is an example diagram illustrating a resource re-evaluation process. As shown in FIG. 5, m1, m2 and m3 are three resources in a plurality of transmissions of one TB, and the m2 and m3 are reserved in an indication of the m1, then at the point in time T3 before the m1 is transmitted, the m1, m2 and m3 need to be re-evaluated. If a resource (assuming the m2) not in the set of the candidate resources after resource re-evaluation is available, resource reselection for the m2 is triggered.

In the resource pre-emption detection process, a resource pre-emption detection is performed on a resource that has been reserved as indicated by the SCI to determine whether the reserved resources are overlapped with the resources occupied by other terminal equipment after a period of time, and the measured RSRP value is greater than the corresponding threshold, and the priority indicated in the SCI corresponding to the resources occupied by other terminal equipment is higher than that of current data to be transmitted. The resource pre-emption detection process is performed based on the physical layer obtaining the set of the candidate resources (Step 1). If a resource is no longer in the set of the candidate resources reported in the resource pre-emption detection process, and the priority indicated in the SCI corresponding to the resource occupied by other terminal equipment that is overlapped with this resource is higher than that of the data to be transmitted, this resource needs to be reselected.

FIG. 6 is an example diagram illustrating a resource pre-emption detection process. As shown in FIG. 6, m1, m2 and m3 are three resources in a plurality of transmissions of one TB, and the m2 and m3 are reserved in an indication of the m1, at a point in time after the m1 is transmitted and before the m2 is transmitted, a UE finds that the m2 resource is preempted, resource reselection of the m2 may be triggered at or before the point in time T3 before the m2 is transmitted.

In Rel-16 NR V2X, the sidelink transmissions is not performed by the terminal equipment or need to be discarded when the corresponding priority is low. Specific reasons include but are not limited to situations: if the terminal equipment wants to transmit a channel/signal of LTE V2X and a channel/signal of NR V2X, and time domain resources occupied by transmission of the channel/signal of LTE V2X and the channel/signal of NR V2X overlap; if the terminal equipment wants to transmit/receive the channel/signal of LTE V2X and receive/transmit the channel/signal of NR V2X, and time domain resources occupied by transmission/reception of the channel/signal of LTE V2X and the channel/signal of NR V2X overlap; and if the terminal equipment has no ability to simultaneously transmit a sidelink (SL) and an uplink (UL) in the same serving cell, and time domain resources occupied by transmission of the sidelink (SL) and the uplink (UL) overlap.

A situation in which the selected resources are reselected within the same period is schematically described above. In Rel-16, reselection of periodic reserved resources is supported, and triggering reasons include but are not limited to the above situation. For the periodic reserved resources, resource reselection may be triggered due to resource re-evaluation, resource pre-emption detection, and low-priority transmission of the sidelink.

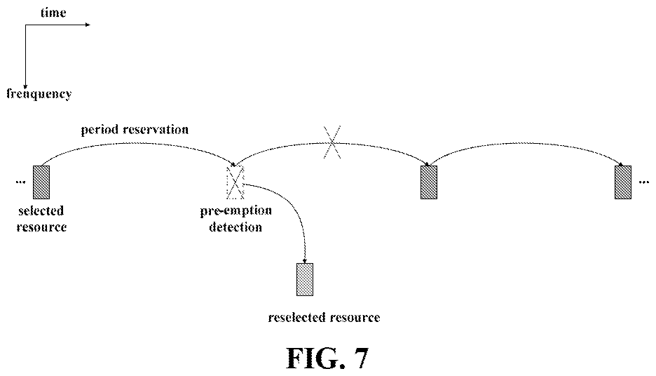

FIG. 7 is an example diagram of reselection of periodic reserved resources. As shown in FIG. 7, for example, if pre-emption occurs on a reserved resource in a period, resource reselection is triggered in a current period and a new resource is selected to transmit a new data packet in the current period.

The inventors found that for a terminal equipment supporting periodic-based partial sensing, in a first period, in order to ensure the reliability of resource selection, complete period-based partial sensing is performed. However, if a subsequent period also uses a first transmission period to perform the complete period-based partial sensing of resource selection for possible triggered resource reselection, power consumption may be increased, and the resource reselection may not be triggered due to the subsequent period, the increased power consumption may be wasted.

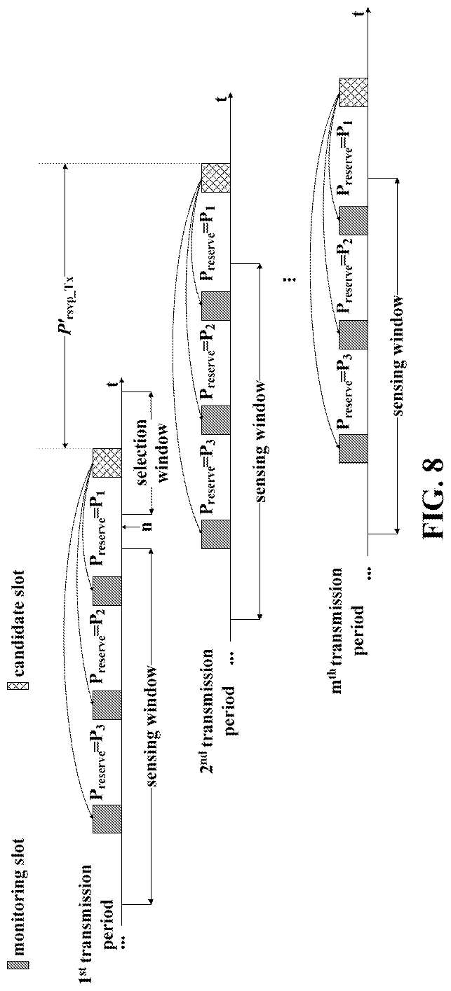

FIG. 8 is an example diagram illustrating power consumption based on periodic-based partial sensing. As shown in FIG. 8, in subsequent periods (such as, a 2^{nd} . . . an m^{th} transmission period), resource reselection may not be triggered. However, if monitoring is still performed on all possible monitoring slots corresponding to candidate slots, power consumption may be increased and unnecessary waste occurs.

In addition, for resource re-evaluation/resource pre-emption detection within one period, the terminal equipment needs to perform resource re-evaluation/resource pre-emption detection at a time point (m-T3) corresponding to a resource m. For a terminal equipment supporting partial sensing, if the resource reselection is triggered, a problem of insufficient time domain resources covered by the selection window corresponding to the reselection may arise.

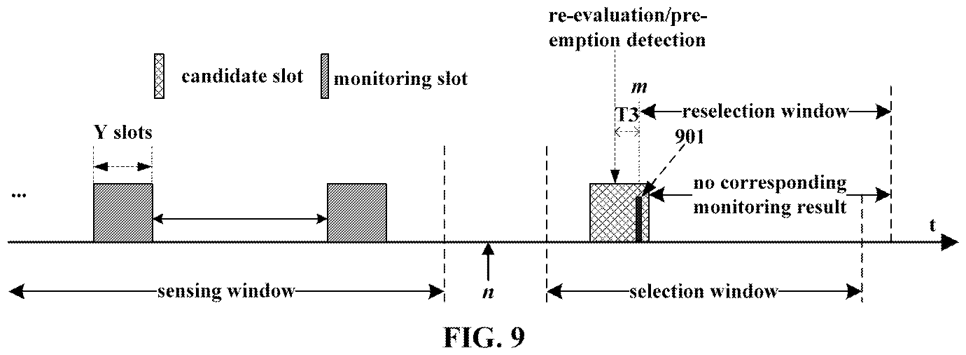

FIG. 9 is an example diagram illustrating insufficient candidate resources caused by resource re-evaluation/resource pre-emption detection in partial sensing. As shown in FIG. 9, the reselection of the resource m is triggered at the time point m-T3, then the number of candidate time domain resources (as shown in 901) in a corresponding reselection window is smaller than a minimum value minNumCandidateSF of candidate time domain resources (Y slots) based on partial sensing, corresponding slots of remaining resources in the reselection window have not been monitored, thus these remaining resources are unable to be used for data transmission. In this way, the number of candidate resources of the reselected resources is reduced, possible interference or probability of resource collisions is increased, and thus system performance is degraded.

In view of at least one of the above problems, embodiments of this disclosure are further described below.

In an embodiment of this disclosure, the sidelink is illustrated by taking V2X as an example, however, this disclosure is not limited thereto, and may also be applied to a sidelink transmission scenario other than the V2X. In the description below, the terms “sidelink” and “V2X” are interchangeable, the terms “PSFCH” and “sidelink feedback channel” are interchangeable, the terms “PSCCH” and “sidelink control channel” or “sidelink control information” are interchangeable, and the terms “PSSCH” and “sidelink data channel” or “sidelink data” are interchangeable, in the absence of confusion.

In addition, transmitting or receiving the PSCCH may be understood as transmitting or receiving sidelink control information carried by the PSCCH; transmitting or receiving the PSSCH may be understood as transmitting or receiving sidelink data carried by the PSSCH; transmitting or receiving the PSFCH may be understood as transmitting or receiving sidelink feedback information carried by the PSFCH. Sidelink transmissions (also referred to as sidelink transmission) may be understood as PSCCH/PSSCH transmission or sidelink data/information transmission.

### Embodiments of a First Aspect

The embodiments of this disclosure provide a method for reselecting a sidelink resource, which is described from a terminal equipment supporting period-based partial sensing. The terminal equipment may transmit sidelink data to other terminal equipment, thus the terminal equipment needs to select resources to determine transmission resources of the sidelink data.

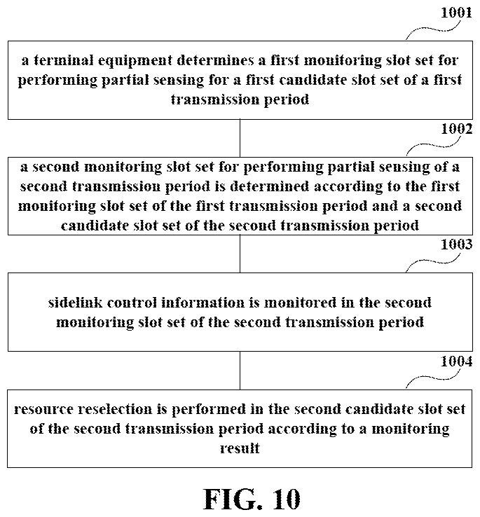

FIG. 10 is a schematic diagram illustrating a method for reselecting sidelink resources according to an embodiment of this disclosure. As shown in FIG. 10, the method includes:
1001: a terminal equipment determines a first monitoring slot set for performing partial sensing for a first candidate slot set of a first transmission period;
1002: a second monitoring slot set for performing partial sensing of a second transmission period is determined according to the first monitoring slot set of the first transmission period and a second candidate slot set of the second transmission period;
1003: sidelink control information is monitored in the second monitoring slot set of the second transmission period; and
1004: resource reselection is performed in the second candidate slot set of the second transmission period according to a monitoring result.

It should be noted that the FIG. 10 only schematically illustrates an embodiment of this disclosure, however, this disclosure is not limited thereto. For example, an order of execution of the operations may be appropriately adjusted, and furthermore, some other operations may be added, or some operations therein may be reduced. And appropriate variants may be made by those skilled in the art according to the above contents, without being limited to what is contained in FIG. 10.

In some embodiments, the first transmission period is a period-based partial sensing first (1^{st}) sidelink data transmission period, and the second transmission period is one (i^{th}, i is greater than 1 and less than or equal to P_{N}) of sidelink data transmission periods other than the periodic-based partial sensing first sidelink data transmission period (e.g., P_{N} in total).

For example, the first transmission period is the first transmission period of periodic transmission, the second transmission period is the second transmission period of periodic transmission, an interval (or offset) between the first transmission period and the second transmission period is one transmission period; or, the first transmission period is the first transmission period of periodic transmission, the second transmission period is a fourth transmission period of periodic transmission, an interval (or offset) between the first transmission period and the second transmission period is three transmission periods.

In some embodiments, a first candidate slot set includes one or more candidate slots (Y slots) in the selection window of the first transmission period, and a first monitoring slot set includes one or more slots (Y slots) in the sensing window of the first transmission period, and reference may be made to a previous disclosure for a corresponding relationship between the first candidate slot set and the first monitoring slot set.

In some embodiments, determining a second monitoring slot set for performing partial sensing in the second transmission period according to the first monitoring slot set of the first transmission period and the second candidate slot set of the second transmission period may include: determining a third monitoring slot set to which the second transmission period corresponds, based on the second candidate slot set of the second transmission period, according to a rule for determining the first monitoring slot set in the first transmission period; and taking all or part of slots in the third monitoring slot set as the second monitoring slot set for performing partial sensing of the second transmission period.

For example, a period-based partial sensing complete sensing pattern may be determined for the reselected second candidate slot set (Y candidate slots in a subsequent period, distinguished from the first candidate slot set of a preliminary selection period), according to the same rule as that for initial resource selection, the complete sensing pattern may be referred to as a third monitoring slot set.

Specifically, for a slot t_{y}_{ⱼ}^{SL} included in the reselected candidate slot set of a current period, a corresponding slot is t_{y}_{ⱼ}_{-k×P}_{ᵣₑₛₑᵣᵥₑ}^{SL}, where j is an index of the current period, and Pᵣₑₛₑᵣᵥₑ is a set of corresponding period values (i.e., values after the slot is converted into a logical slot) that need to be monitored for one candidate slot when the UE performs period-based partial sensing, which may be a full set or a sub-set of a candidate period set configured by a period set parameter sl-ResourceReservePeriodList of which a period reservation is allowed in a resource pool; k is the number of periods between the candidate slots and the corresponding slots, and k is an integer greater than or equal to 1. One or more values may be taken for k, wherein when more values are taken for k, it means that for a period that needs to be monitored corresponding to a selected candidate slot, the corresponding number of monitoring that is required is greater than 1. For each of the candidate slots, for each Pᵣₑₛₑᵣᵥₑ, the UE determines corresponding one or more k values respectively, so as to obtain a corresponding slot that needs to be monitored for the candidate slot.

After the third monitoring slot set is determined, all or part of slots in the third monitoring slot set may be used as the second monitoring slot set for performing partial sensing of the second transmission period. For example, a reduced sensing pattern (the second monitoring slot set) is determined by taking a subset from the complete sensing pattern (the third monitoring slot set).

In some embodiments, taking all or part of slots in the third monitoring slot set as the second monitoring slot set for performing partial sensing of the second transmission period includes: taking one or more slots after a reference time in the third monitoring slot set as the second monitoring slot set for performing partial sensing of the second transmission period.

For example, the reference time is at least one of:
a slot where sidelink transmission in a last period before a current transmission period is located;
a slot before sidelink transmission in a last period before a current transmission period, the slot being a slot of a processing time point before the sidelink transmission in the last period, the processing time point and the sidelink transmission being at least spaced apart by a processing time length (T3), for example, the time point is (m-T3), where the m is the slot in which the sidelink transmission is located; or
a slot before sidelink transmission in a last period before a current transmission period, the slot being a slot between the processing time point before the sidelink transmission in the last period and a slot where the sidelink transmission in the last period is located.

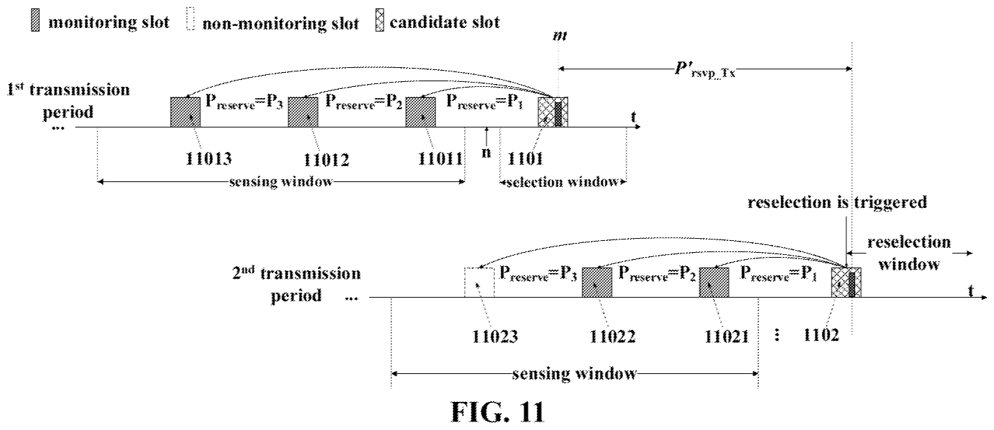

FIG. 11 is a schematic diagram illustrating determination of a second monitoring slot set according to an embodiment of this disclosure. As shown in FIG. 11, a first monitoring slot set for performing partial sensing (including slot sets as shown in 11011, 11012 and 11013) may be determined according to a first candidate slot set (as shown in 1101) of the first transmission period. According to a rule for determining the first monitoring slot set in the first transmission period, a third monitoring slot set (including slot sets as shown in 11021, 11022 and 11023) corresponding to the second transmission period may be determined based on a second candidate slot set (as shown in 1102) of the second transmission period.

As shown in FIG. 11, the slot set 11021 and the slot set 11022 are located after the reference time (as shown in the slot m), thus the slot set 11021 and the slot set 11022 are taken as the second monitoring slot set for performing partial sensing of the second transmission period (including the slot sets as shown in 11021 and 11022), whereas the slot set 11023 is not included in the second monitoring slot set because the slot set 11023 is located before the reference time (as shown in the slot m).

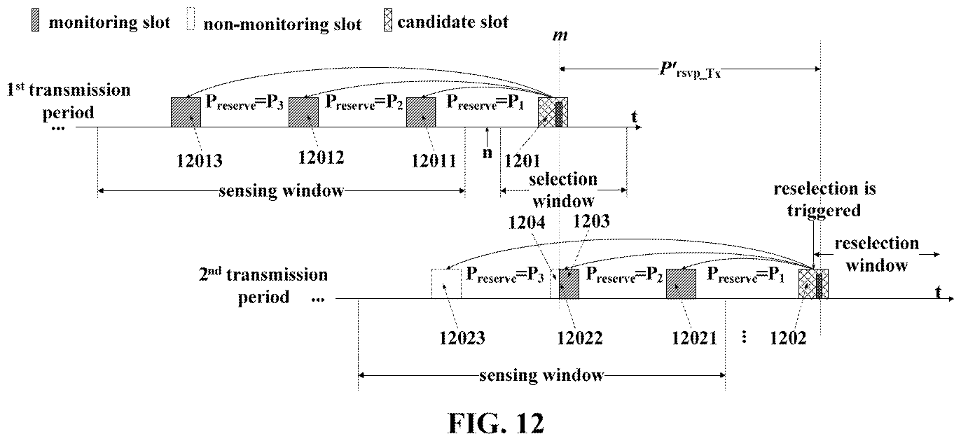

FIG. 12 is another schematic diagram illustrating determination of a second monitoring slot set according to an embodiment of this disclosure. As shown in FIG. 12, a first monitoring slot set for performing partial sensing (including slot sets as shown in 12011, 12012 and 12013) may be determined according to a first candidate slot set (as shown in 1201) of the first transmission period. According to a rule for determining the first monitoring slot set in the first transmission period, a third monitoring slot set (including slot sets as shown in 12021, 12022 and 12023) corresponding to the second transmission period may be determined based on a second candidate slot set (as shown in 1202) of the second transmission period.

As shown in FIG. 12, the slot set 12021 is located after the reference time (as shown in the slot m), and a part of the slots (as shown in 1203) of the slot set 12022 is also located after the reference time (as shown in the slot m), therefore, the slot set 12021 and the slot set 1203 are taken as the second monitoring slot set (including the slot sets as shown in 12021 and 1203) for performing partial sensing of the second transmission period, whereas the slot set 12023 is located before the reference time (as shown in the slot m), and therefore is not included in the second monitoring slot set, the other part of the slots (as shown in 1204) of the slot set 12022 is also located before the reference time (as shown in the slot m), and therefore is not included in the second monitoring slot set either.

The reference time of the embodiments of this disclosure is schematically described above, however, this disclosure is not limited thereto. Therefore, unnecessary power consumption may be avoided and the effect of saving power may be improved by performing monitoring only on a part of the corresponding slots corresponding to the second period.

In some embodiments, taking all or part of slots in the third monitoring slot set as the second monitoring slot set for performing partial sensing of the second transmission period includes: taking one or more slots in the third monitoring slot set with a corresponding reserved period length less than a period threshold as the second monitoring slot set for performing partial sensing of the second transmission period. For example, the period threshold includes 100 ms, however, this disclosure is not limited thereto.

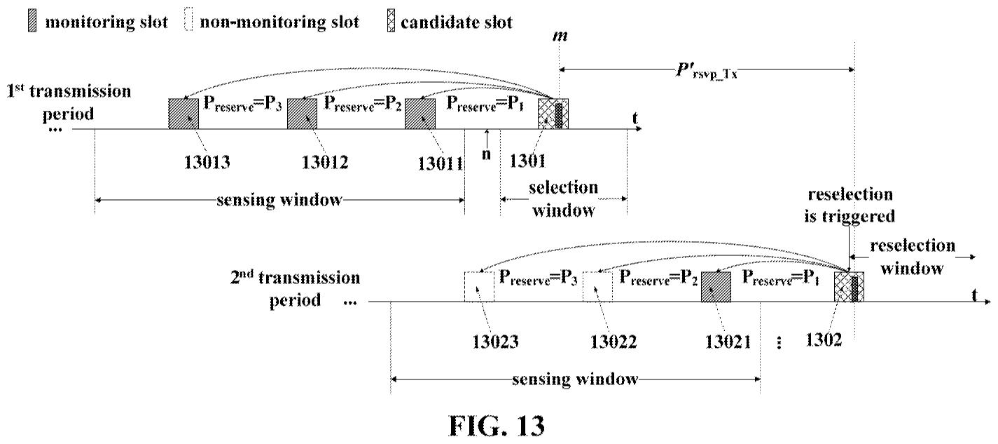

FIG. 13 is another schematic diagram illustrating determination of a second monitoring slot set according to an embodiment of this disclosure. As shown in FIG. 13, a first monitoring slot set for performing partial sensing (including slot sets as shown in 13011, 13012 and 13013) may be determined according to a first candidate slot set (as shown in 1301) of the first transmission period. According to a rule for determining the first monitoring slot set in the first transmission period, a third monitoring slot set (including slot sets as shown in 13021, 13022 and 13023) corresponding to the second transmission period may be determined based on a second candidate slot set (as shown in 1302) of the second transmission period.

As shown in FIG. 13, a reserved period corresponding to the slot set 13021 is P1 with a length less than the period threshold (e.g., 100 ms), and a reserved period corresponding to the slot set 13022 is P2 with a length greater than or equal to the period threshold (e.g., 100 ms), a reserved period corresponding to the slot set 13023 is P3 with a length greater than or equal to the period threshold (e.g., 100 ms). Therefore, the slot set 13021 is taken as the second monitoring slot set (including the slot set as shown in 13021) for performing partial sensing of the second transmission period, whereas the slot sets 13022 and 13023 are not included in the second monitoring slot set.

Therefore, unnecessary power consumption may be avoided and the effect of saving power may be improved by performing monitoring only on a part of the corresponding slots.

In some embodiments, taking all or part of slots in the third monitoring slot set as the second monitoring slot set for performing partial sensing of the second transmission period includes: randomly selecting one or more slots from the third monitoring slot set as the second monitoring slot set for performing partial sensing of the second transmission period.

For example, still taking FIG. 13 as an example, one or more slots may be randomly selected from the slot sets 13021, 13022 and 13023, for example, the slot set 13021 is selected; the randomly selected slot set 13021 is taken as the second monitoring slot set for performing partial sensing of the second transmission period.

Therefore, unnecessary power consumption may be avoided and the effect of saving power may be improved by performing monitoring only on a part of the corresponding slots.

In some embodiments, one or more slots before and/or after resource reselection is triggered, or one or more consecutive slots before and/or after a first candidate slot are taken as the second monitoring slot set for performing partial sensing of the second transmission period.

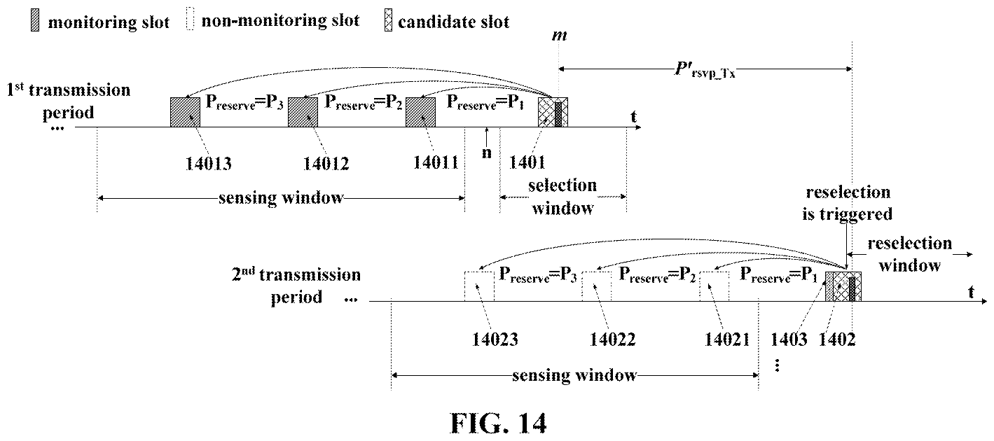

FIG. 14 is another schematic diagram illustrating determination of a second monitoring slot set according to an embodiment of this disclosure. As shown in FIG. 14, a first monitoring slot set for performing partial sensing (including slot sets as shown in 14011, 14012 and 14013) may be determined according to a first candidate slot set (as shown in 1401) of the first transmission period. According to a rule for determining the first monitoring slot set in the first transmission period, a third monitoring slot set (including slot sets as shown in 14021, 14022 and 14023) corresponding to the second transmission period may be determined based on a second candidate slot set (as shown in 1402) of the second transmission period.

As shown in FIG. 14, the slot sets 14021, 14022 and 14023 may not be monitored, however, one or more consecutive slots (as shown in 1403) before the first candidate slots of the second candidate slot set (as shown in 1402) are monitored, which may be referred to as contiguous partial sensing. In this way, the interference caused by aperiodic services to a current transmission may be excluded.

For another example, if monitoring is performed on one or more consecutive slots after and/or before resource reselection is triggered, the resource reselection may not need to determine Y candidate slots, and the reselection window is not limited to the Y candidate slots or all resources in the reselection window may be used as candidate resources; and the resource selection process starts only after consecutive monitoring time elapses.

Therefore, unnecessary power consumption may be avoided and the effect of saving power may be improved by performing monitoring only on a part of consecutive slots.

In some embodiments, sidelink control information is not monitored for the second candidate slot set of the second transmission period, and reselected resources of the second transmission period are randomly selected.

Therefore, the reselected resources are not monitored, unnecessary power consumption may be avoided and the effect of power saving may be improved.

The monitoring slots used for resource reselection are schematically described above, and the candidate slots used for resource reselection are described below.

In some embodiments, the terminal equipment takes the first candidate slot set of the first transmission period as the second candidate slot set of the second transmission period after translating the first candidate slot set of the first transmission period backwards by N current transmission periods in the time domain, where N is the number of periods spacing the second transmission period and the first transmission period apart.

For example, Y candidate slots of a subsequent period may be limited, that is, they are obtained by translating the preliminarily selected Y candidate slots in the current transmission period. Specifically, if the slot t_{y}^{SL} in the first period is included in the selected candidate slot set (Y slots), for the subsequent period, a slot t_{y+j*P′}_{_{rsvp_TX}}^{SL}, j=0, 1, 2 . . . is also included in the candidate slot set (Y slots) of the corresponding subsequent period, where j is an index of period, j=0 represents the first period, j=1 represents the second transmission period; P′_{rsvp_TX} represents the number of the slots after the period value of the current transmission is converted into a logical slot.

For one period, units of Pᵣₛᵥₚ may be converted from milliseconds to P′ᵣₛᵥₚ in the logical slot, as indicated in Equation (1) below:

$${P}_{rsvp}^{′} = ⌈ \frac{N}{20 ms} \times {P}_{rsvp} ⌉ \qquad ( 1 )$$

among which, N is the number of slots that may be used for sidelink transmission within 20 ms. A conversion between slots and milliseconds is only schematically illustrated above, and the related art may also be referred to for the specific disclosure.

The above implementations only illustrate the embodiments of this disclosure. However, this disclosure is not limited thereto, and appropriate variants may also be made on the basis of these implementations. For example, the above implementations may be executed separately, or one or more of them may be executed in a combined manner.

It may be known from the embodiments that the second monitoring slot set for performing partial sensing of the second transmission period is determined according to the first monitoring slot set of the first transmission period and the second candidate slot set of the second transmission period; thus the resource reselection may be monitored on a part of the slots, unnecessary power consumption may be avoided and the effect of power saving may be improved.

### Embodiments of a Second Aspect

The embodiments of this disclosure provide a method for reselecting a sidelink resource, with contents identical to those in the embodiments of the first aspect being not going to be described herein any further.

In some embodiments, the terminal equipment takes the first candidate slots of the first transmission period as the second candidate slot set of the second transmission period after translating the first candidate slots of the first transmission period backwards by N current transmission periods in the time domain, where N is the number of periods spacing the second transmission period and the first transmission period apart.

In some embodiments, the terminal equipment determines a first monitoring slot set for performing partial sensing for a first candidate slot set of the first transmission period.

In some embodiments, the terminal equipment determines a second monitoring slot set for performing partial sensing for the second candidate slot set of the second transmission period; monitors sidelink control information in the second monitoring slot set of the second transmission period; and reselects resources in the second candidate slot set of the second transmission period according to a monitoring result.

In some embodiments, the first transmission period is a period-based partial sensing first sidelink data transmission period, and the second transmission period is one of sidelink data transmission periods other than the period-based partial sensing first sidelink data transmission period.

In some embodiments, the candidate slot set used for reselection includes a corresponding slot in which the slot where the selected resource of the first transmission period is located is translated backwards by j periods P, where j is an index of period, and j=0, 1, 2 . . . , P is a transmission period. For example, if t_{y} is the slot where the selected resource of the first transmission period is located, t_{y+j*P} is included in the candidate slot set used for reselection in the (j+1)^{th} transmission period, where j is the index of period and P is the transmission period.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Third Aspect

The embodiments of this disclosure provide a method for reselecting a sidelink resource, which is described from a terminal equipment supporting partial sensing. The terminal equipment may transmit sidelink data to other terminal equipment, thus the terminal equipment needs to select resources to determine transmission resources of the sidelink data.

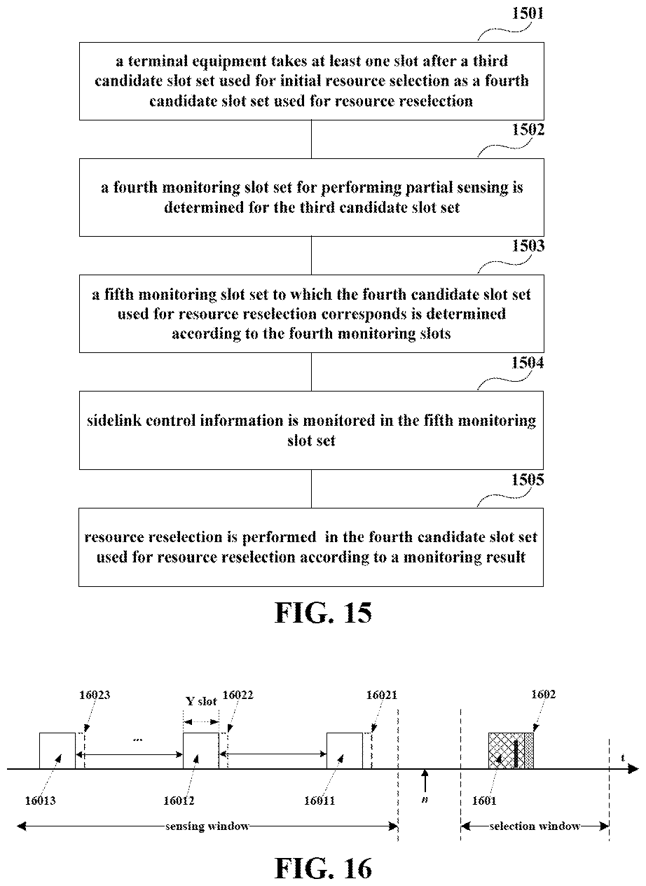

FIG. 15 is a schematic diagram illustrating a method for reselecting sidelink resources according to an embodiment of this disclosure. As shown in FIG. 15, the method includes:
1501: a terminal equipment takes at least one slot after a third candidate slot set used for initial resource selection as a fourth candidate slot set used for resource reselection;
1502: a fourth monitoring slot set for performing partial sensing is determined for the third candidate slot set;
1503: a fifth monitoring slot set to which the fourth candidate slot set used for resource reselection corresponds is determined according to the fourth monitoring slots;
1504: sidelink control information is monitored in the fifth monitoring slot set; and
1505: resource reselection is performed in the fourth candidate slot set used for resource reselection according to a monitoring result.

It should be noted that the FIG. 15 only schematically illustrates the embodiment of this disclosure, however, this disclosure is not limited thereto. For example, an order of execution of the operations may be appropriately adjusted, and furthermore, some other operations may be added or some operations therein may be reduced. And appropriate variants may be made by those skilled in the art according to the above contents, without being limited to what is contained in FIG. 15.

In some embodiments, initial resource selection and resource reselection are performed for one transmission period; however, this disclosure is not limited thereto. At least one consecutive slot after the candidate slot used for initial resource selection may be used as a candidate slot used for resource reselection. That is, the resource reselection in the period is not limited to the preliminary selection of the Y candidate slots, and the slots after the preliminary selection of the Y candidate slots may also be additionally selected as the candidate slots used for resource reselection, and therefore, the number of candidate resources during resource reselection may be increased.

In some embodiments, the candidate slots used for reselection are included in the slot set for the selected resources of the current period in which the reselection is triggered. For example, if t_{y} is a slot where the preempted resource is located, t_{y} is also included in the candidate slot set used for reselection.

In some embodiments, determining a fifth monitoring slot set to which the fourth candidate slot set used for resource reselection corresponds according to the fourth monitoring slot set includes: determining a sixth monitoring slot set corresponding to the fourth candidate slot set used for resource reselection, according to a rule for determining the fourth monitoring slot set; and taking all or part of slots in the sixth monitoring slot set as the fifth monitoring slot set.

FIG. 16 is a schematic diagram illustrating determination of a sixth monitoring slot set according to an embodiment of this disclosure. As shown in FIG. 16, a fourth monitoring slot set (including slot sets as shown in 16011, 16012 and 16013) for performing partial sensing may be determined according to the third candidate slot set used for initial resource selection (as shown in 1601, including Y slots).

As shown in FIG. 16, one or more slots (as shown in 1602) after the third candidate slot set (as shown in 1601, including Y slots) may be used as a fourth candidate slot set used for resource reselection; a sixth monitoring slot set (including slot sets as shown in 16021, 16022 and 16023) corresponding to the fourth candidate slot set (as shown in 1602) may be determined, according to a rule for determining the fourth monitoring slot set.

After the sixth monitoring slot set is determined, all or part of slots in the sixth monitoring slot set may be used as the fifth monitoring slot set for performing partial sensing. For example, a reduced sensing pattern (the fifth monitoring slot set) is determined by taking a subset from the complete sensing pattern (the sixth monitoring slot set).

In some embodiments, taking all or part of slots in the sixth monitoring slot set as the fifth monitoring slot set includes: taking one or more slots in the sixth monitoring slot set after a reference time as the fifth monitoring slot set.

For example, the reference time is at least one of:
a slot where last sidelink transmission before current sidelink transmission in which reselection is triggered is located;
a slot before last sidelink transmission before current sidelink transmission in which reselection is triggered, the slot being a slot where a processing time point before the last sidelink transmission is located, the processing time point and the last sidelink transmission being at least spaced apart by a processing time length (T3); or
a slot before last sidelink transmission before current sidelink transmission in which reselection is triggered, the slot being a slot between the processing time point before the last sidelink transmission and a slot where the last sidelink transmission is located.

The current sidelink transmission and the last sidelink transmission are retransmissions and initial transmissions of an identical transport block (TB), respectively; or, the current sidelink transmission and the last sidelink transmission are an (M+1)-th retransmission and an M-th retransmission of the identical transport block (TB), respectively, where M is a positive integer.

In some embodiments, taking all or part of slots in the sixth monitoring slot set as the fifth monitoring slot set includes: taking one or more slots in the sixth monitoring slot set with a corresponding reserved period length less than a period threshold as the fifth monitoring slot set. For example, the period threshold includes 100 ms.

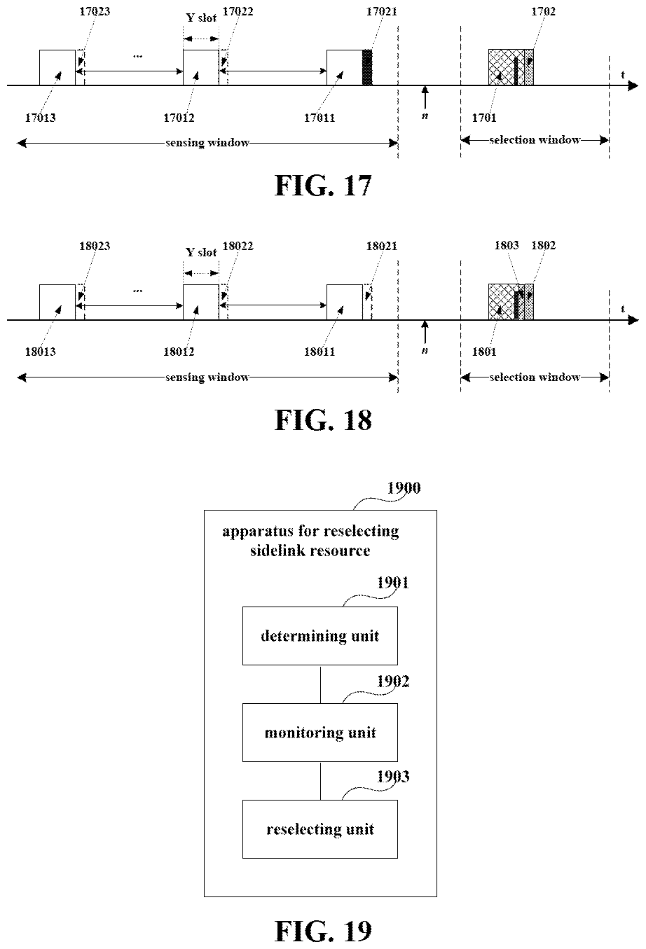

FIG. 17 is a schematic diagram illustrating determination of a fifth monitoring slot set according to an embodiment of this disclosure. As shown in FIG. 17, a fourth monitoring slot set (including slot sets as shown in 17011, 17012 and 17013) for performing partial sensing may be determined according to a third candidate slot set (as shown in 1701, including Y slots) for initial resource selection.

As shown in FIG. 17, one or more slots (as shown in 1702) after the third candidate slot set (as shown in 1701, including Y slots) may be used as a fourth candidate slot set used for resource reselection; a sixth monitoring slot set (including slot sets as shown in 17021, 17022 and 17023) corresponding to the fourth candidate slot set (as shown in 1702) may be determined according to a rule for determining the fourth monitoring slot set.

As shown in FIG. 17, a reserved period corresponding to the slot sets 17023 and 17022 is greater than or equal to 100 ms, and a reserved period corresponding to the slot set 17021 is less than 100 ms, thus the slot set 17021 is used as the fifth monitoring slot set.

Therefore, unnecessary power consumption may be further avoided and the effect of power saving may be improved by performing monitoring only on a part of the slots.

In some embodiments, taking all or part of slots in the sixth monitoring slot set as the fifth monitoring slot set includes: randomly selecting one or more slots from the sixth monitoring slot set as the fifth monitoring slot set.

For example, still taking FIG. 17 as an example, one or more slots may be randomly selected from the slot sets 17021, 17022 and 17023, for example, the slot set 17023 is selected, and therefore, the slot set 17023 is taken as the fifth monitoring slot set.

Therefore, unnecessary power consumption may be further avoided and the effect of power saving may be improved by performing monitoring only on a part of the slots.

In some embodiments, one or more slots before and/or after resource reselection is triggered, or one or more consecutive slots before and/or after the first candidate slot, are taken as the fifth monitoring slot set.

FIG. 18 is another schematic diagram illustrating determination of a fifth monitoring slot set according to an embodiment of this disclosure. As shown in FIG. 18, the fourth monitoring slot set for performing partial sensing (including slot sets as shown in 18011, 18012, 18013 and 18014) may be determined according to the third candidate slot set used for initial resource selection (as shown in 1801, including Y slots).

As shown in FIG. 18, one or more slots (as shown in 1802) after a third candidate slot set (as shown in 1801, including Y slots) may be used as a fourth candidate slot set used for resource reselection; a sixth monitoring slot set (including slot sets as shown in 18021, 18022 and 18023) corresponding to the fourth candidate slot set (as shown in 1802) may be determined, according to a rule for determining the fourth monitoring slot set.

As shown in FIG. 18, the slot sets 18021, 18022 and 18023 may not be monitored, however, one or more consecutive slots (as shown in 1803) before the first candidate slot of the fourth candidate slot set (as shown in 1802) are monitored, which may be referred to as contiguous partial sensing. In this way, the interference caused by aperiodic services to a current transmission may be excluded.

FIG. 18 only exemplarily illustrates the fifth monitoring slot set, which is illustrated by taking the consecutive slots after the Y candidate slots as an example, however, this disclosure is not limited thereto. For example, the consecutive slots may also be monitored before or after other time points, and these consecutive slots are used as the fifth monitoring slot set. Then, resources are selected within a slot window after monitoring, and the slot window may include Y candidate slots, or may include slots after the Y candidate slots.

For another example, if one or more consecutive slots are monitored after and/or before resource reselection is triggered, the resource reselection may not need to determine the Y candidate slots, and all resources in the reselection window may be used as candidate resources; and the resource selection process starts only after a period of consecutive monitoring time elapses.

Therefore, unnecessary power consumption may be further avoided and the effect of power saving may be improved by performing monitoring only on a part of consecutive slots.

In some embodiments, sidelink control information is not monitored for the fourth candidate slot set, and reselected resources corresponding to the fourth candidate slot set are randomly selected.

Therefore, the reselected resources are not monitored, unnecessary power consumption may be avoided and the effect of power saving may be improved.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It may be known from the embodiments that at least one slot after the candidate slot set used for initial resource selection is used as the candidate slot set used for resource reselection; thus the number of candidate resources during resource reselection may be increased, the possible interference may be reduced or the probability of resource collisions may be reduced, and the system performance may be improved.

### Embodiments of a Fourth Aspect

The embodiments of this disclosure provide an apparatus for reselecting a sidelink resource. The apparatus may be, for example, a terminal equipment, or may be a or some components or assembles configured in the terminal equipment, with contents identical to those in the embodiments of the first and second aspects being not going to be described herein any further.

FIG. 19 is a schematic diagram illustrating an apparatus for reselecting sidelink resources according to an embodiment of this disclosure. As shown in FIG. 19, an apparatus for reselecting sidelink resources 1900 includes: a determining unit 1901, a monitoring unit 1902 and a reselecting unit 1903.

In some embodiments, the determining unit 1901 determines a first monitoring slot set for performing partial sensing for a first candidate slot set of a first transmission period, and determines a second monitoring slot set for performing partial sensing of a second transmission period according to the first monitoring slot set of the first transmission period and a second candidate slot set of the second transmission period; the monitoring unit 1902 monitors sidelink control information in the second monitoring slot set of the second transmission period; and the reselecting unit 1903 reselects resources in the second candidate slot set of the second transmission period according to a monitoring result.

In some embodiments, the first transmission period is a periodic-based partial sensing first sidelink data transmission period, and the second transmission period is one of sidelink data transmission periods other than the periodic-based partial sensing first sidelink data transmission period.

In some embodiments, the determining unit 1901 is configured to: determine a third monitoring slot set to which the second transmission period corresponds based on the second candidate slot set of the second transmission period, according to a rule for determining the first monitoring slot set in the first transmission period; and take all or part of slots in the third monitoring slot set as the second monitoring slot set for performing partial sensing of the second transmission period.

In some embodiments, the determining unit 1901 is configured to: take one or more slots after a reference time in the third monitoring slot set as the second monitoring slot set for performing partial sensing of the second transmission period.

In some embodiments, the reference time is at least one of:
a slot where sidelink transmission in a last period before a current transmission period is located;
a slot before sidelink transmission in a last period before a current transmission period, the slot being a slot of a processing time point before the sidelink transmission in the last period, the processing time point and the sidelink transmission being at least spaced apart by a processing time length; or
a slot before sidelink transmission in a last period before a current transmission period, the slot being a slot between the processing time point before the sidelink transmission in the last period and a slot where the sidelink transmission in the last period is located.

In some embodiments, the determining unit 1901 is configured to: take one or more slots in the third monitoring slot set with a corresponding reserved period length less than a period threshold as the second monitoring slot set for performing partial sensing of the second transmission period.

In some embodiments, the determining unit 1901 is configured to: randomly select one or more slots from the third monitoring slot set as the second monitoring slot set for performing partial sensing of the second transmission period.

In some embodiments, the determining unit 1901 is configured to: take one or more slots before and/or after resource reselection is triggered, or one or more consecutive slots before and/or after a first candidate slot, as the second monitoring slot set for performing partial sensing of the second transmission period.

In some embodiments, the determining unit 1901 is further configured to: take the first candidate slot set of the first transmission period as the second candidate slot set of the second transmission period after translating the first candidate slot set of the first transmission period backwards by N current transmission periods in the time domain, wherein N is the number of periods spacing the second transmission period and the first transmission period apart.

In some embodiments, the reselecting unit 1903 is further configured to: not monitor the sidelink control information for the second candidate slot set of the second transmission period, reselected resources of the second transmission period being randomly selected.

In some embodiments, the determining unit 1901 takes the first candidate slots of the first transmission period as the second candidate slot set of the second transmission period after translating the first candidate slots of the first transmission period backwards by N current transmission periods in the time domain, where N is the number of periods spacing the second transmission period and the first transmission period apart.

In some embodiments, the determining unit 1901 is further configured to: determine a first monitoring slot set for performing partial sensing for the first candidate slot set of the first transmission period; and determine a second candidate slot set for performing partial sensing for the second candidate slot set of the second transmission period.

In some embodiments, the monitoring unit 1902 monitors sidelink control information in the second monitoring slot set of the second transmission period; and the reselecting unit 1903 reselects resources in the second candidate slot set of the second transmission period according to a monitoring result.

In some embodiments, the first transmission period is a periodic-based partial sensing first sidelink data transmission period, and the second transmission period is a sidelink data transmission period other than the periodic-based partial sensing first sidelink data transmission period.

In some embodiments, the determining unit 1901 takes at least one slot after a third candidate slot set used for initial resource selection as a fourth candidate slot set used for resource reselection, determines a fourth monitoring slot set for performing partial sensing for the third candidate slot set, and determines a fifth monitoring slot set to which the fourth candidate slot set used for resource reselection corresponds according to the fourth monitoring slots; the monitoring unit 1902 monitors sidelink control information in the fifth monitoring slot set; and the reselecting unit 1903 reselects resources in the fourth candidate slot set used for resource reselection according to a monitoring result.

In some embodiments, the determining unit 1901 is configured to: determine a sixth monitoring slot set to which the fourth candidate slot set used for resource reselection corresponds according to a rule for determining the fourth monitoring slot set; and take all or part of slots in the sixth monitoring slot set as the fifth monitoring slot set.

In some embodiments, the determining unit 1901 is configured to: take one or more slots in the sixth monitoring slot set after a reference time as the fifth monitoring slot set, and/or take one or more slots in the sixth monitoring slot set with a corresponding reserved period length less than a period threshold as the fifth monitoring slot set, and/or randomly select one or more slots from the sixth monitoring slot set as the fifth monitoring slot set.

In some embodiments, the reference time is at least one of:
a slot where last sidelink transmission before current sidelink transmission in which reselection is triggered is located;
a slot before last sidelink transmission before current sidelink transmission in which reselection is triggered, the slot being a slot where a processing time point before the last sidelink transmission is located, the processing time point and the last sidelink transmission being at least spaced apart by a processing time length; or
a slot before last sidelink transmission before current sidelink transmission in which reselection is triggered, the slot being a slot between the processing time point before the last sidelink transmission and a slot where the last sidelink transmission is located;

In some embodiments, the current sidelink transmission and the last sidelink transmission are retransmissions and initial transmissions of an identical transport block (TB), respectively; or, the current sidelink transmission and the last sidelink transmission are an (M+1)-th retransmission and an M-th retransmission of the identical transport block, respectively; where M is a positive integer.

In some embodiments, the determining unit 1901 is further configured to: take one or more slots before and/or after resource reselection is triggered, or one or more consecutive slots before and/or after a first candidate slot, as the fifth monitoring slot set.

In some embodiments, the reselecting unit 1903 is further configured to: not monitor the sidelink control information for the fourth candidate slot set, reselected resources to which the fourth candidate slot set corresponds being randomly selected.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above, however, this disclosure is not limited thereto. The apparatus for reselecting sidelink resources 1900 may further include other components or modules, and reference may be made to the related techniques for particulars of these components or modules.

In addition, for the sake of simplicity, connection relationships between the components or modules or signal profiles thereof are only exemplarily shown in FIG. 19. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It may be known from the embodiments that the second monitoring slot set for performing partial sensing of the second transmission period is determined according to the first monitoring slot set of the first transmission period and the second candidate slot set of the second transmission period; thus monitoring of resource reselection may be performed on a portion of the slots, unnecessary power consumption may be avoided and the effect of power saving may be improved.

In addition, at least one slot after the candidate slot set used for initial resource selection is used as the candidate slot set used for resource reselection; thus the number of candidate resources during resource reselection may be increased, the possible interference may be reduced or the probability of resource collisions may be reduced and the system performance may be improved.

### Embodiments of a Fifth Aspect

The embodiments of this disclosure provide a communication system. Reference may be made to FIG. 1, with contents identical to those in the embodiments of the first to the fourth aspects being not going to be described herein any further.

In some embodiments, the communication system 100 may at least include:
a terminal equipment configured to determine a first monitoring slot set for performing partial sensing for a first candidate slot set of a first transmission period, and determine a second monitoring slot set for performing partial sensing of a second transmission period according to the first monitoring slot set of the first transmission period and a second candidate slot set of the second transmission period; monitor sidelink control information in the second monitoring slot set of the second transmission period; and reselect resources in the second candidate slot set of the second transmission period according to a monitoring result.

In some embodiments, the communication system 100 may at least include:
a terminal equipment configured to take the first candidate slots of the first transmission period as the second candidate slot set of the second transmission period after translating the first candidate slots of the first transmission period backwards by N current transmission periods in the time domain, where N is the number of periods spacing the second transmission period and the first transmission period apart.

In some embodiments, the communication system 100 may at least include:
a terminal equipment configured to take at least one slot after a third candidate slot set used for initial resource selection as a fourth candidate slot set used for resource reselection, determine a fourth monitoring slot set for performing partial sensing for the third candidate slot set, determine a fifth monitoring slot set to which the fourth candidate slot set used for resource reselection corresponds according to the fourth monitoring slots; monitor sidelink control information in the fifth monitoring slot set; and reselect resources in the fourth candidate slot set used for resource reselection according to a monitoring result.

An embodiment of this disclosure also provides a network device, which may be, for example, a base station, however, this disclosure is not limited thereto, and the network device may also be other network devices.

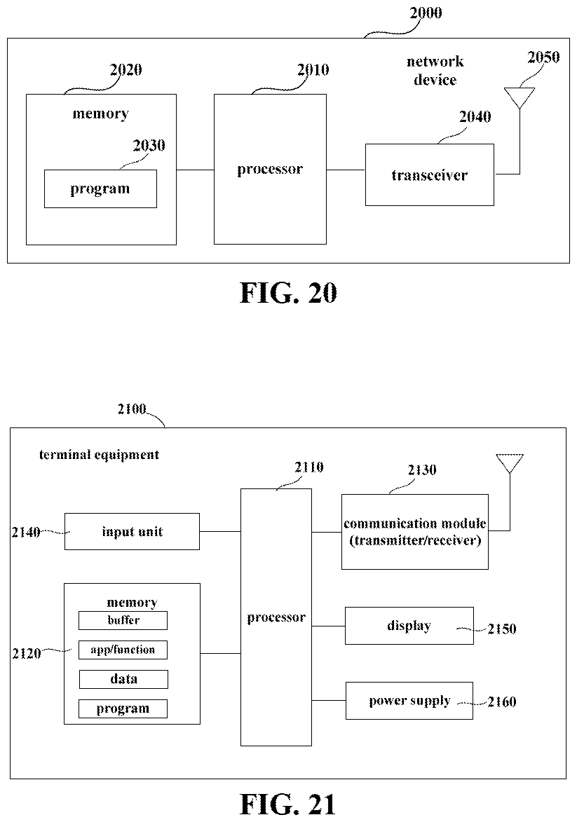

FIG. 20 is a schematic diagram illustrating a network device according to an embodiment of this disclosure. As shown in FIG. 20, a network device 2000 may include: a processor 2010 (e.g., a central processing unit (CPU)) and a memory 2020. The memory 2020 is coupled to the processor 2010. The memory 2020 may store various data and may also store a program 2030 for information processing, and the program 2030 is executed under the control of the processor 2010.

In addition, as shown in FIG. 20, the network device 2000 may further include: a transceiver 2040, an antenna 2050; wherein functions of the above components are similar to those in the related art, which shall not be described herein any further. It should be noted that the network device 2000 does not necessarily include all the components shown in FIG. 20. Furthermore, the network device 2000 may also include components not shown in FIG. 20, and reference may be made to the related art.

An embodiment of this disclosure also provides a terminal equipment; however, this disclosure is not limited thereto, and other devices may also be provided.

FIG. 21 is a schematic diagram illustrating a terminal equipment according to an embodiment of this disclosure. As shown in FIG. 21, the terminal equipment 2100 may include a processor 2110 and a memory 2120. The memory 2120 stores data and programs, and is coupled to the processor 2110. It should be noted that this figure is illustrative, and other types of structures may be used, so as to supplement or replace this structure and achieve telecommunication functions or other functions.

For example, the processor 2110 may be configured to execute a program in order to implement the method for reselecting sidelink resources in the embodiments of the first aspect. For example, the processor 2110 may be configured to: determine a first monitoring slot set for performing partial sensing for a first candidate slot set of a first transmission period, determine a second monitoring slot set for performing partial sensing of a second transmission period according to the first monitoring slot set of the first transmission period and a second candidate slot set of the second transmission period; monitor sidelink control information in the second monitoring slot set of the second transmission period; and reselect resources in the second candidate slot set of the second transmission period according to a monitoring result.

For another example, the processor 2110 may be configured to execute a program in order to implement the method for reselecting sidelink resources in the embodiments of the second aspect. For example, the processor 2110 may be configured to take the first candidate slots of the first transmission period as the second candidate slot set of the second transmission period after translating the first candidate slots of the first transmission period backwards by N current transmission periods in the time domain, where N is the number of periods spacing the second transmission period and the first transmission period apart.

For another example, the processor 2110 may be configured to execute a program in order to implement the method for reselecting sidelink resources in the embodiments of the third aspect. For example, the processor 2110 may be configured to take at least one slot after the third candidate slot set used for initial resource selection as the fourth candidate slot set used for resource reselection; determine a fourth monitoring slot set for performing partial sensing for the third candidate slot set; determine a fifth monitoring slot set corresponding to the fourth candidate slot set used for resource reselection according to the fourth monitoring slots; monitor sidelink control information in the fifth monitoring slot set; and reselect resources in the fourth candidate slot set used for resource reselection according to a monitoring result.

As shown in FIG. 21, the terminal equipment 2100 may further include: a communication module 2130, an input unit 2140, a display 2150, and a power supply 2160; wherein functions of the above components are similar to those in the relevant art, which shall not be described herein any further. It should be noted that the terminal equipment 2100 does not necessarily include all the components shown in FIG. 21, and the above components are not required. Furthermore, the terminal equipment 2100 may also include components not shown in FIG. 21, and the related art may be referred to.

An embodiment of this disclosure further provides a computer program, which, when is executed in a terminal equipment, causes the terminal equipment to implement the method for reselecting sidelink resources according to the embodiments of the first to third aspects.

An embodiment of this disclosure further provides a storage medium storing a computer program, wherein the computer program enables a terminal equipment to implement the method for reselecting sidelink resources in the embodiments of the first to third aspects. The above devices and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/devices described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, supplements are further disclosed as follows:

1. A method for reselecting a sidelink resource, including:
determining, by a terminal equipment, a first monitoring slot set for performing partial sensing for a first candidate slot set of a first transmission period;
determining a second monitoring slot set for performing partial sensing of a second transmission period according to the first monitoring slot set of the first transmission period and a second candidate slot set of the second transmission period;
monitoring sidelink control information in the second monitoring slot set of the second transmission period; and
performing resource reselection in the second candidate slot set of the second transmission period according to a monitoring result.
2. The method according to supplement 1, wherein the first transmission period is a period-based partial sensing first sidelink data transmission period, and the second transmission period is one of sidelink data transmission periods other than the period-based partial sensing first sidelink data transmission period.
3. The method according to supplement 1 or 2, wherein determining a second monitoring slot set for performing partial sensing of a second transmission period according to the first monitoring slot set of the first transmission period and a second candidate slot set of the second transmission period includes:
determining a third monitoring slot set to which the second transmission period corresponds, based on the second candidate slot set of the second transmission period, according to a rule for determining the first monitoring slot set in the first transmission period; and
taking all or part of slots in the third monitoring slot set as the second monitoring slot set for performing partial sensing of the second transmission period.
4. The method according to supplement 3, wherein taking all or part of slots in the third monitoring slot set as the second monitoring slot set for performing partial sensing of the second transmission period includes:
taking one or more slots after a reference time in the third monitoring slot set as the second monitoring slot set for performing partial sensing of the second transmission period.
5. The method according to supplement 4, wherein the reference time is at least one of:
a slot where sidelink transmission in a last period before a current transmission period is located;
a slot before sidelink transmission in a last period before a current transmission period, the slot being a slot of a processing time point before the sidelink transmission in the last period, the processing time point and the sidelink transmission being at least spaced apart by a processing time length (T3); or
a slot before sidelink transmission in a last period before a current transmission period, the slot being a slot between the processing time point before the sidelink transmission in the last period and a slot where the sidelink transmission in the last period is located.
6. The method according to any one of supplements 3 to 5, wherein taking all or part of slots in the third monitoring slot set as the second monitoring slot set for performing partial sensing of the second transmission period includes:
taking one or more slots in the third monitoring slot set with a corresponding reserved period length less than a period threshold as the second monitoring slot set for performing partial sensing of the second transmission period.
7. The method according to supplement 6, wherein the period threshold includes 100 ms.
8. The method according to any one of supplements 3 to 7, wherein taking all or part of slots in the third monitoring slot set as the second monitoring slot set for performing partial sensing of the second transmission period includes:
randomly selecting one or more slots from the third monitoring slot set as the second monitoring slot set for performing partial sensing of the second transmission period.
9. The method according to any one of supplements 1 to 8, wherein the method further includes:
taking one or more slots before and/or after resource reselection is triggered, or one or more consecutive slots before and/or after a first candidate slot, as the second monitoring slot set for performing partial sensing of the second transmission period.
10. The method according to any one of supplements 1 to 9, wherein the method further includes:
taking the first candidate slot set of the first transmission period as the second candidate slot set of the second transmission period after translating the first candidate slot set of the first transmission period backwards by N current transmission periods in the time domain, where N is the number of periods spacing the second transmission period and the first transmission period apart.
11. The method according to any one of supplements 1 to 10, wherein the method further includes:
not monitoring the sidelink control information for the second candidate slot set of the second transmission period, reselected resources of the second transmission period being randomly selected.
12. A method for reselecting sidelink resources, including:
taking, by a terminal equipment, first candidate slots of a first transmission period as a second candidate slot set of a second transmission period after translating the first candidate slots of the first transmission period backwards by N current transmission periods in the time domain, where N is the number of periods spacing the second transmission period and the first transmission period apart.
13. The method according to supplement 12, wherein the method further includes:
determining, by the terminal equipment, a first monitoring slot set for performing partial sensing for a first candidate slot set of the first transmission period.
14. The method according to supplement 12 or 13, wherein the method further includes:
determining, by the terminal equipment, a second monitoring slot set for performing partial sensing for the second candidate slot set of the second transmission period;
monitoring sidelink control information in the second monitoring slot set of the second transmission period; and
performing resource reselection in the second candidate slot set of the second transmission period according to a monitoring result.
15. The method according to any one of supplements 12 to 14, wherein the first transmission period is a period-based partial sensing first sidelink data transmission period, and the second transmission period is one of sidelink data transmission periods other than the period-based partial sensing first sidelink data transmission period.
16. A method for reselecting sidelink resources, including:
taking, by a terminal equipment, at least one slot after a third candidate slot set used for initial resource selection as a fourth candidate slot set used for resource reselection;
determining a fourth monitoring slot set for performing partial sensing for the third candidate slot set;
determining a fifth monitoring slot set to which the fourth candidate slot set used for resource reselection corresponds according to the fourth monitoring slots;
monitoring sidelink control information in the fifth monitoring slot set; and
performing resource reselection in the fourth candidate slot set used for resource reselection according to a monitoring result.
17. The method according to supplement 16, wherein determining a fifth monitoring slot set to which the fourth candidate slot set used for resource reselection corresponds according to the fourth monitoring slot set includes:
determining a sixth monitoring slot set to which the fourth candidate slot set used for resource reselection corresponds according to a rule for determining the fourth monitoring slot set; and
taking all or part of slots in the sixth monitoring slot set as the fifth monitoring slot set.
18. The method according to supplement 17, wherein taking all or part of slots in the sixth monitoring slot set as the fifth monitoring slot set includes:
taking one or more slots in the sixth monitoring slot set after a reference time as the fifth monitoring slot set.
19. The method according to supplement 18, wherein the reference time is at least one of:
a slot where last sidelink transmission before current sidelink transmission in which reselection is triggered is located;
a slot before last sidelink transmission before current sidelink transmission in which reselection is triggered, the slot being a slot where a processing time point before the last sidelink transmission is located, the processing time point and the last sidelink transmission being at least spaced apart by a processing time length (T3); or
a slot before last sidelink transmission before current sidelink transmission in which reselection is triggered, the slot being a slot between the processing time point before the last sidelink transmission and a slot where the last sidelink transmission is located.
20. The method according to supplement 19, wherein the current sidelink transmission and the last sidelink transmission are retransmissions and initial transmissions of an identical transport block (TB), respectively; or,
the current sidelink transmission and the last sidelink transmission are an (M+1)-th retransmission and an M-th retransmission of the identical transport block (TB), respectively, where M is a positive integer.
21. The method according to any one of supplements 17 to 20, wherein taking all or part of slots in the sixth monitoring slot set as the fifth monitoring slot set, includes:
taking one or more slots in the sixth monitoring slot set with a corresponding reserved period length less than a period threshold as the fifth monitoring slot set.
22. The method according to supplement 21, wherein the period threshold includes 100 ms.
23. The method according to any one of supplements 17 to 22, wherein taking all or part of slots in the sixth monitoring slot set as the fifth monitoring slot set includes:
randomly selecting one or more slots from the sixth monitoring slot set as the fifth monitoring slot set.
24. The method according to any one of supplements 16 to 23, wherein the method further includes:
taking one or more slots before and/or after resource reselection is triggered, or one or more consecutive slots before and/or after a first candidate slot, as the fifth monitoring slot set.
25. The method according to any one of supplements 16 to 24, wherein the method further includes:
not monitoring the sidelink control information for the fourth candidate slot set, the reselected resources to which the fourth candidate slot set corresponds being randomly selected.
26. A terminal equipment, including a memory and a processor, wherein the memory stores a computer program, and the processor is configured to execute the computer program to implement the method for reselecting sidelink resources according to any one of supplements 1 to 25.
27. A communication system, including:
a terminal equipment configured to determine a first monitoring slot set for performing partial sensing for a first candidate slot set of a first transmission period; and determine a second monitoring slot set for performing partial sensing of a second transmission period according to the first monitoring slot set of the first transmission period and a second candidate slot set of the second transmission period; monitor sidelink control information in the second monitoring slot set of the second transmission period; and performing resource reselection in the second candidate slot set of the second transmission period according to a monitoring result.
28. A communication system, including:
a terminal equipment configured to take first candidate slots of a first transmission period as a second candidate slot set of a second transmission period after translating the first candidate slots of the first transmission period backwards by N current transmission periods in the time domain, where N is the number of periods spacing the second transmission period and the first transmission period apart.
29. A communication system, including:
a terminal equipment configured to take at least one slot after a third candidate slot set used for initial resource selection as a fourth candidate slot set used for resource reselection; determine a fourth monitoring slot set for performing partial sensing for the third candidate slot set; determine a fifth monitoring slot set to which the fourth candidate slot set used for resource reselection corresponds according to the fourth monitoring slots; monitor sidelink control information in the fifth monitoring slot set; and performing resource reselection in the fourth candidate slot set used for resource reselection according to a monitoring result.

What is claimed is:

1. An apparatus for reselecting a sidelink resource, the apparatus comprising:
a memory; and
a processor coupled to the memory and configured to:
take one or more candidate slots as a second candidate slot set of a second transmission period; wherein the one or more candidate slots are obtained based on one or more first candidate slots of a first transmission period and N transmission periods; where, N is the number of periods spacing the second transmission period and the first transmission period apart.

2. The apparatus according to claim 1, wherein
the processor is further configured to:
determine a first monitoring slot set for performing partial sensing for a first candidate slot set of the first transmission period, and
determine a second monitoring slot set for performing partial sensing for the second candidate slot set of the second transmission period.

3. The apparatus according to claim 2, further comprising:
a monitor configured to monitor sidelink control information in the second monitoring slot set of the second transmission period,
wherein the processor is further configured to perform resource reselection in the second candidate slot set of the second transmission period according to a monitoring result.

4. The apparatus according to claim 1, wherein the first transmission period is a first sidelink data transmission period in performing periodic-based partial sensing, and the second transmission period is one of sidelink data transmission periods other than the first sidelink data transmission period in performing periodic-based partial sensing.

5. An apparatus for reselecting a sidelink resource, comprising:
a processor coupled to a memory and configured to:
determine a first monitoring slot set for performing partial sensing for a first candidate slot set of a first transmission period, and determine a second monitoring slot set for performing partial sensing of a second transmission period according to the first monitoring slot set of the first transmission period and a second candidate slot set of the second transmission period; and
a monitor configured to monitor sidelink control information in the second monitoring slot set of the second transmission period;
wherein the processor is further configured to perform resource reselection in the second candidate slot set of the second transmission period according to a monitoring result.

6. The apparatus according to claim 5, wherein the first transmission period is a periodic-based partial sensing first sidelink data transmission period, and the second transmission period is one of sidelink data transmission periods other than the periodic-based partial sensing first sidelink data transmission period.

7. The apparatus according to claim 5, wherein the processor is further configured to determine a third monitoring slot set to which the second transmission period corresponds, based on the second candidate slot set of the second transmission period, according to a rule for determining the first monitoring slot set in the first transmission period, and take all or part of slots in the third monitoring slot set as the second monitoring slot set for performing partial sensing of the second transmission period.

8. The apparatus according to claim 7, wherein the processor is further configured to take one or more slots after a reference time in the third monitoring slot set as the second monitoring slot set for performing partial sensing of the second transmission period.

9. The apparatus according to claim 8, wherein the reference time is at least one of:
a slot where sidelink transmission in a last period before a current transmission period is located;
a slot before sidelink transmission in a last period before a current transmission period, the slot being a slot of a processing time point before the sidelink transmission in the last period, the processing time point and the sidelink transmission being at least spaced apart by a processing time length; or
a slot before sidelink transmission in a last period before a current transmission period, the slot being a slot between the processing time point before the sidelink transmission in the last period and a slot where the sidelink transmission in the last period is located.

10. The apparatus according to claim 7, wherein the processor is further configured to take one or more slots in the third monitoring slot set with a corresponding reserved period length less than a period threshold as the second monitoring slot set for performing partial sensing of the second transmission period.

11. The apparatus according to claim 7, wherein processor is further configured to randomly select one or more slots from the third monitoring slot set as the second monitoring slot set for performing partial sensing of the second transmission period.

12. The apparatus according to claim 5, wherein the processor is further configured to take one or more slots before and/or after resource reselection is triggered or one or more consecutive slots before and/or after a first candidate slot as the second monitoring slot set for performing partial sensing of the second transmission period.

13. The apparatus according to claim 5, wherein the processor is further configured to take the first candidate slot set of the first transmission period as the second candidate slot set of the second transmission period after translating the first candidate slot set of the first transmission period forwards by N current transmission periods in the time domain, where N is the number of periods spacing the second transmission period and the first transmission period apart.

14. The apparatus according to claim 5, wherein the sidelink control information is not monitored for the second candidate slot set of the second transmission period, on or more reselected resources of the second transmission period being randomly selected. An apparatus for reselecting a sidelink resource, comprising:
a processor configured to take at least one slot after a third candidate slot set used for initial resource selection as a fourth candidate slot set used for resource reselection, determine a fourth monitoring slot set for performing partial sensing for the third candidate slot set, and determine a fifth monitoring slot set to which the fourth candidate slot set used for resource reselection corresponds according to the fourth monitoring slots;
a monitor configured to monitor sidelink control information in the fifth monitoring slot set;
wherein the processor is further configured to perform resource reselection in the fourth candidate slot set used for resource reselection according to a monitoring result.

16. The apparatus according to claim 15, wherein the processor is further configured to determine a sixth monitoring slot set to which the fourth candidate slot set used for resource reselection corresponds, according to a rule for determining the fourth monitoring slot set, and take all or part of slots in the sixth monitoring slot set as the fifth monitoring slot set.

17. The apparatus according to claim 16, wherein the processor is further configured to:
take one or more slots in the sixth monitoring slot set after a reference time as the fifth monitoring slot set, and/or
take one or more slots in the sixth monitoring slot set with a corresponding reserved period length less than a period threshold as the fifth monitoring slot set, and/or
randomly select one or more slots from the sixth monitoring slot set as the fifth monitoring slot set.

18. The apparatus according to claim 17, wherein the reference time is at least one of:
a slot where last sidelink transmission before a sidelink transmission in which reselection is triggered is located;
a slot before last sidelink transmission before a sidelink transmission in which reselection is triggered, the slot being a slot where a processing time point before the last sidelink transmission is located, the processing time point and the last sidelink transmission being at least spaced apart by a processing time length; or
a slot before last sidelink transmission before a sidelink transmission in which reselection is triggered, the slot being a slot between the processing time point before the last sidelink transmission and a slot where the last sidelink transmission is located,
wherein the sidelink transmission and the last sidelink transmission are retransmissions and initial transmissions of an identical transport block, respectively; or, the sidelink transmission and the last sidelink transmission are an (M+1)-th retransmission and an M-th retransmission of the identical transport block, respectively, where M is a positive integer.

19. The apparatus according to claim 15, wherein the processor is further configured to take one or more slots before and/or after resource reselection is triggered, or one or more consecutive slots before and/or after a first candidate slot, as the fifth monitoring slot set.

20. The apparatus according to claim 15, wherein the sidelink control information is not monitored for the fourth candidate slot set, one or more reselected resources to which the fourth candidate slot set corresponds being randomly selected.
